(19) United States
(12) Patent Application Publication
(10) Pub. No.: US 2008/0280036 A1
(43) Pub. Date: Nov. 13, 2008

(54) FIRE-RESISTANT POLYMERIC PEEL-OFF COATING COMPOSITIONS AND METHOD OF USE THEREOF

(75) Inventor: ROBERT MESA, Santa Clara, CA (US)

Correspondence Address: BEYER WEAVER LLP, P.O. BOX 70250, OAKLAND, CA, 94612-0250, US

(73) Assignee: Cal-West Specialty Coatings, Sunnyvale, CA (US)

(21) Appl. No.: 11/871,321

(22) Filed: Oct. 12, 2007

Related U.S. Application Data
(60) Provisional application No. 60/851,711, filed on Oct. 12, 2006.

(51) Int. Cl. C09D 5/00; C04B 24/26; C08K 5/101; C04B 103/67

(52) U.S. Cl. 427/154; 524/5; 524/315; 523/122

(57) ABSTRACT

Methods and compositions are provided for protecting exterior surfaces of automobiles and other products, or components of products, against abrasion, abrasive dust, water, acid rain, etc. The methods involve applying to a surface a protective coating composition comprising an emulsion selected from the group consisting of a vinyl-acrylic copolymer emulsion and a vinyl acetate-ethylene emulsion combined with a flame retardant. The emulsion is dried to form a water-resistant protective coating that can be removed from the underlying surface by peeling when no longer desired.

### CROSS-REFERENCE TO RELATED APPLICATIONS

This application claims benefit of and priority to U.S. Ser. No. 60/851,711, filed on Oct. 12, 2006, which is incorporated herein by reference in its entirety for all purposes.

### STATEMENT AS TO RIGHTS TO INVENTIONS MADE UNDER FEDERALLY SPONSORED RESEARCH AND DEVELOPMENT

[Not Applicable]

### FIELD OF THE INVENTION

This invention relates to the field of protective coatings. In particular embodiments, this invention relates to peelable protective coatings comprising vinyl-acrylic copolymer and/or a vinyl acetate ethylene emulsion and a fire retardant.

### BACKGROUND OF THE INVENTION

The present invention relates to surface protective coatings and more specifically to peel-off (peelable) coatings effective for protecting exposed surfaces of various products and components. In particular, the coatings are suitable for protection of vehicles and vehicle components, oil and gas rigs, windmills, gas lines, ships, boats, aircraft, trucks and buses.

The surface paint finishes of new vehicles are subject to a variety of injuries both during the assembly process and during transportation from the assembly plant to retail locations. These finishes are especially prone to damage in the first month following manufacture because the paint has not had sufficient time to cure. Typical sources of damage include acid rain, bird droppings and “rail dust”, a cloud of hard, abrasive particles which rises from a rail bed as a train passes over the rails. Rail dust is an especially difficult problem for car manufacturers as many cars are transported form assembly plants or dockyards to retail markets by rail. The damage inflicted on the vehicles' surface finish during transit can be quite severe, even requiring shipment back to the assembly plant for complete repainting.

In addition to new vehicles, other products are also subjected to abrasive and deleterious conditions during transit, and during fabrication and assembly into other products. For instance, storm windows and other glass products must be specially protected to avoid scratching and marring during road and rail transit. Deck cargo is also susceptible to surface damage caused by salt water and other factors. Similarly, many products must be protected during fabrication or assembly by downstream manufacturers. For example, plastic laminates such as Formica™ and other materials with high-gloss finishes such as bathroom fixtures and chrome plated or brass surfaces must be protected not only during shipping, but during installation or assembly into other products.

Various approaches have been utilized to protect the exposed surfaces of vehicles, vehicle components, and other products during manufacture and transportation. The simplest approach, physical protection with solid coatings (e.g., covering the vehicle or component with plastic or canvas) is effective, but it is labor intensive and therefore prohibitively expensive for mass shipments. Plastic sheeting, for example, is as much as ten times more expensive to use than chemical coating solutions due to higher material costs and the amount of labor needed to properly apply the sheetings. In addition it is difficult, time consuming and sometimes virtually impossible to apply solid sheet coatings to complex or convoluted surfaces.

Solution-type protective compositions are known, but have not found widespread use because of the damage which may possibly occur to the underlying or adjacent surfaces. These compositions are often difficult to remove from certain surfaces (e.g. underlying plastics). Also, traditional chemical methods suffer from high cost and the health and environmental dangers posed by solvent-based solutions and coatings.

Aqueous emulsion type coatings are also easily applied and eliminate the problems associated with various organic solvent systems. The most widely used are polyvinyl acetate emulsions or acrylic resin emulsions. These emulsions, however, are defective with respect to heat stability, resistance to water and stability in storage, and low drying velocity after application. For example, those disclosed in Japanese Patent Publication No. 14770/73 which are prepared by adding floury materials such as calcium carbonate and titanium dioxide, silicone resin and an aqueous emulsion of paraffin wax are defective in their poor stability when stored for a long time, and also in their low drying velocity after application. In addition many coatings tend to cross-link, particularly after exposure to sunlight (UV radiation) or elevated temperature, and become very difficult to remove.

### SUMMARY OF THE INVENTION

This invention pertains to novel coating materials that can be applied to a surface, dry to form a dry protective film, and can be removed from the surface by peeling. Unlike typical peelable polymer coatings, the coating described herein show heightened fire and flame resistance, even when lifted off the underlying surface. The coating are thus particularly useful in environments subject to flame, spark, electrically or other fire-causing hazards (e.g., in various manufacturing and shop applications). In certain embodiments the coatings comprise an aqueous solution or mixture comprising a vinyl-acrylic copolymer and/or vinyl acetate ethylene emulsion; a plasticizer; and a fire retardant. In various embodiments the emulsion is an aqueous emulsion. In certain embodiments the emulsion is FLEXBOND™ 325, FLEXBOND™ 381, and/or AIRFLEX™ 320. In various embodiments the plasticizer comprises PARAPLEX™ WP1, and/or TEXANOL™. In various embodiments the fire retardant comprises a catalyst/initiator; a carbonific, a cement, a blowing agent, and a heat resistant inorganic material. In various embodiments the flame retardant comprises TSWB™ (Avtec Industries). In various embodiments the coating can also further comprise a pigment (e.g., titanium dioxide) and/or a defoamer, and/or a biocide. In certain embodiments the emulsion is a vinyl-acrylic copolymer emulsion comprising at least 50%, by weight, of the coating composition before drying; the plasticizer comprises about 1% to about 5%, by weight, of said coating composition before drying; the fire retardant comprises about 15% to about 30%, by weight of said composition. In certain embodiments the composition further comprises a thickener, where the thickener comprises less than about 3%, by weight, of the coating composition before drying and/or a pigment, and where the pigment comprises less than about 10%, by weight, of the coating composition before drying. In various embodiments the coating composition comprises a formulation shown in Table 3.

In various embodiments methods of protecting a surface are provided. The methods typically involve applying to the surface that is to be protected a liquid coating composition comprising as described herein, and drying the coating composition to form, on the surface, a substantially continuous protective film. In certain embodiments the applying is by a means selected from the group consisting of a sprayer, a brush, a roller, and/or a doctor bar. In certain embodiments the drying comprises air drying the composition at room temperature or at an elevated temperature. In certain embodiments the method can further involve removing said composition from said surface. In various embodiments the film is completely or partially removed by peeling the protective film from the underlying surface. In certain embodiments the surface is a surface of an article of manufacture such as a motor vehicle, a motor vehicle component, a bathroom fixture, a plumbing fixture, a tool, a machine, a laminated countertop, a table top, a window assembly, a door assembly, a stove, a refrigerator, a microwave oven, an aluminum tank, a wheel, furniture, a plated or chromed part, a bumper, an instrument panel, a shelf, a portion of an oil rig, a portion of an aircraft, a portion of a windmill, a cabinet, and the like.

Also provided are articles of manufacture all or partially coated with a protective coating composition as described herein. The articles of manufacture include, but are not limited to all or a part or portion of a motor vehicle, a motor vehicle component, a bathroom fixture, a plumbing fixture, a tool, a machine, a laminated countertop, a table top, a window assembly, a door assembly, a stove, a refrigerator, a microwave oven, an aluminum tank, a wheel, furniture, a plated or chromed part, a bumper, an instrument panel, a shelf, an oil rig, an aircraft, a windmill, a cabinet, and the like.

Methods of transporting an article of manufacture are also provided, the methods typically involve applying to all or a portion of a surface of the article of manufacture a coating composition as described herein; drying the coating composition to form, on the surface, a substantially continuous protective film; and iii) transporting the article (e.g., by hand, by automobile, by truck, by ship, by air, etc.). In various embodiments the method further involves removing said protective coating composition after transporting the article of manufacture. In certain embodiments the protective coating composition is removed by mechanical peeling.

### DEFINITIONS

The terms “fire retardant” or “flame retardant” are used interchangeably to refer to materials that increase the combustion temperature and/or reduce the ability of fire to propagate in a material.

A peelable film is a film that can be removed from an underlying surface by mechanical peeling.

When a film forming composition is referred to as a “fluid, before drying” this refers to the composition as formulated without substantial subsequent evaporation and/or drying.

### BRIEF DESCRIPTION OF THE DRAWINGS

FIG. 1 illustrates removal of the protective coating from the surface of an automobile by peeling.

### DETAILED DESCRIPTION

The present invention relates to the discovery that vinyl-acrylic copolymer emulsions typically used for interior and exterior paints, and vinyl acetate ethylene emulsions, typically used as adhesives, and compositions comprising such emulsions, can also be used as peelable protective coatings on a wide variety of surfaces. In addition, this invention pertains to the surprising discovery that a fire retardant can be incorporated into the film forming mixture without adversely affecting the properties (e.g., tensile strength, flexibility, peelability, protective ability, etc.) of the film.

The incorporation of a fire retardant greatly increases the safety and versatility of the peelable film. In particular, the incorporation of a flame retardant significantly reduces the flammability of the coating when the coating is a free-film not adhered to a substrate. Without the fire retardant free films produced by peelable vinyl-acrylic or vinyl acetate ethylene emulsions are extremely flammable and relatively dangerous in a number of commercial environments.

In many of our applications, there are cases where the peelable film is pulled away from part of a substrate to allow work on the exposed portion. Welding would be an example of this. In this example, the welding sparks/spatter could ignite the free film that was pulled away from the substrate. Incorporation of flame retardants as described herein renders the free film substantially inflammable thereby eliminating this danger.

The emulsions, and compositions thereof, are typically applied as wet (aqueous formulations) to a surface to be protected, and dried to produce a protective a film that adheres well to the underlying surface. The dry, protective film has few or no pinholes. Further, the dry protective film may be removed easily by simple mechanical peeling (i.e., by hand, or with the aid of a peeling tool).

It was a surprising discovery that the vinyl-acrylic copolymer emulsions and vinyl acetate ethylene emulsions, in combination with flame retardants as described herein, can be used as removable (peelable) coatings. Vinyl-acrylic copolymer emulsions (e.g., FLEXBOND™ 325 or 381 from Air Products and Chemicals, Inc., and UCAR™ 379GT, UCAR™ Latex 367 Vinyl Acrylic Latex, UCAR™ Latex 379G Vinyl Acrylic from Dow, etc.) are typically used as principle components of interior and exterior paints (see, e.g. FLEXBOND™ 325 Technical Data Sheets available from Air Products, and Chemicals, Inc., Allentown, Pa., USA). As paint film formers, the vinyl-acrylic copolymer emulsions are designed to adhere strongly to the underlying surface and to resist subsequent removal. Easy peelability is not seen as a desirable property in a paint by those of skill in the art.

Similarly, vinyl-acetate ethylene emulsions (e.g., AIRFLEX™ emulsions by Air Products, and Chemicals, Inc.) are typically used as adhesives. In particular, they are used as adhesives where good water resistance is desired. Again, prior to this invention one of skill would not view these adhesive compositions as suitable candidates for peelable protective coatings.

Since the emulsions are relatively inflammable when adhered to an underlying surface, flammability has not been regarded as a particular or important property.

In various embodiments the vinyl-acrylic copolymer emulsions and vinyl acetate ethylene emulsions can be used as peelable coatings “straight out of the can” when compounded only with a flame retardant. The emulsions adequately wet and adhere to the surfaces to which they are applied and yet can be easily peeled off without the use of releasing agents. Thus in one preferred embodiment, the coatings use the emulsion in the form provided by the manufacturer combined with a flame retardant. In such embodiments, the coating compositions, before drying, comprise essentially about 5% to about 50% flame retardant, preferably about 10% to about 40% flame retardant, more preferably about 20% to about 30% flame retardant and remainder vinyl-acrylic copolymer emulsion and/or and vinyl acetate ethylene emulsion. Other additives, however, may be present, e.g., as described below. In such instances, the vinyl-acrylic copolymer emulsion and/or and vinyl acetate ethylene emulsion ranges from about 30% or 40% to about 99%, preferably from about 50% to about 98%, more preferably from about 60% to about 80%, and most preferably from about 60% to about 80% of the coating composition, before drying.

In certain embodiments, e.g., where pigments or other components are added to the basic emulsion, compounding requires only simple admixing the components (or aqueous solutions, dispersions, etc. thereof) at substantially atmospheric pressure so as to form a substantially homogeneous mixture. Thus an advantage of the present invention is the relatively simple formulation and therefore low labor costs in producing the coatings.

Preferred emulsions for use in the methods of this invention include vinyl-acrylic emulsions typically used in paints and vinyl acetate-ethylene emulsions typically used for adhesives. Particularly preferred emulsions are aqueous emulsions and are well known to hose of skill in the art. Preferred vinyl-acrylic copolymer emulsions include, but are not limited to FLEXBOND® 149, 150, 153, 165, 185, 325, 825, or 845 (Air Products and Chemicals, Inc.), with FLEXBOND® 325 and FLEXBOND® 381 being most preferred. Preferred vinyl acetate-ethylene emulsions include AIRFLEX™ emulsions (e.g., AIRFLEX® 320, AIRFLEX® AIRFLEX® 4500, AIRFLEX® 4514, AIRFLEX® 4534 etc.) and the like, with AIRFLEX® 320 being most preferred.

In certain embodiments FLEXBOND® 325 (available from Air Products, Inc., is particularly preferred. FLEXBOND® 325 is predominantly an aqueous emulsion of vinyl acetate polymers (see, e.g., Table 1).

TABLE 1
FLEXBOND ® 325 composition.

| | | Concentration |
|---|---|---|
| Components | CAS Number | (weight) |
| Vinyl acetate polymers | | 50%-65% |
| Water | 7732-18-5 | 40%-60% |
| Vinyl acetate monomer | 108-05-4 | <0.5% |

Any of a variety of flame retardant agents can be used in the formulations of this invention. In various embodiments the flame retardant is an intumescent fire retardant smoke suppressing polymer additive. Such additives include, but are not limited to bicyclic phosphites, phosphonates, thiophosphates, and selenophosphates (see, e.g., U.S. Pat. No. 3,293,327), fire-retardant coating compositions containing carbonifics, film-forming binders and phosphorous materials (see, e.g., U.S. Pat. Nos. 3,562,197; 3,513,114; 4,009,137; 4,166,743 and 4,247,435, which are incorporated herein by reference), amide polyphosphate condensates (see, e.g., U.S. Pat. No. 3,969,291 which is incorporated herein by reference), a solvent-based heat-resistant and fire-retardant coating containing carbonifics, film-forming binders, phosphorous materials smoke suppressed flame retardant thermoset compositions (see, e.g., U.S. Pat. No. 5,356,568, which is incorporated herein by reference) and the like.

In certain embodiments the flame retardant material comprises a powder that can be mixed with resins includes a carbonific material, a heat activated blowing agent, a heat activated halogen material, a phosphate material, and an inorganic material (e.g., a heat-resistant inorganic material) as described in U.S. Pat. No. 6,930,138 which is incorporated by reference herein. Such inorganic materials include, but are not limited to silica, calcium aluminate, various minerals, ceramics, and the like.

As described in the U.S. Pat. No. 6,930,138, which is incorporated herein by reference in its entirety for all purposes, certain flame retardants comprise a combination of ingredients as shown in Table 2.

TABLE 2
Illustrative flame retardant composition, e.g.,
as described in U.S. Pat. No. 6,930,138.

| Ingredient | Wgt. % Range | Function |
|---|---|---|
| Dipentaerythritol | 10.0-12.0 | carbonific |
| Melamine | 15.5-17.5 | blowing agent |
| Chlorinated Paraffin - 40% | 4.0-6.0 | halogen material |
| Chlorinated Paraffin - 70% | 8.0-11.0 | halogen material |
| Ammonium polyphosphat | 27.5-29.9 | phosphorous |
| Tris(betachloroethyl)phosphate | 2.5-4.5 | phosphorous |
| Silica flour (120 mesh | 8.5-10.5 | inorganic |
| Glass beads-Zeosphere | 2.5-4.5 | inorganic |
| Calcium aluminate cement | 12.5-14.5 | inorganic |

One preferred commercially formulation of such a flame retardant is Eco-Additive 20 (available from Avtec Industries), a combination of TWSB™ and crystalline graphite.

While it was a discovery of this invention that the above-described emulsions, when compounded with a flame retardant, provide suitable fire-resistant peelable coatings without additives, the coating compositions may contain a variety of other materials such as cosolvents and coalescers, antioxidants, antiozonates, UV stabilizers, colorants, defoamers, corrosion inhibitors, and the like.

In one embodiment, the coating compositions can be compounded with a pigment. The pigment is largely used for coloration. However, without being bound to a particular theory, it is believed that the pigment may also contribute to long term chemical stability of the composition through ultraviolet-blocking. In addition, the pigment may contribute to mechanical strength and stability of the composition (when dried as a film) by acting as a filler. Finally, it is believed that the pigment can help to decrease the water sensitivity of the composition.

In various embodiments the pigment is a finely divided material that contributes to optical and other properties of the coating. The pigment is typically insoluble in the coating medium (e.g., the aqueous dispersion) and is typically mechanically mixed with the coating and deposited when the coating dries. The physical properties of the pigment are typically not changed by incorporation in and deposition from the coating. Preferred pigments include, but are not limited to, inorganic “white” pigments although colored and certain organic pigments are also suitable. Inorganic white pigments suitable for this invention include, but are not limited to, titanium dioxide, white lead, zinc oxide, lithopone (a mixture of zinc sulfide and barium sulfate), zinc sulfide and antimony oxide. Titanium dioxide (e.g., TI-PURE™ R-902, DuPont Chemicals, Wilmington, Del., USA) is particularly suitable for the present invention because high efficiency (unit opacity/weight). The pigment may be present at about 1% to about 20%, more preferably about 1% or 2% to about 8% or 10% and most preferably about 4% to about 6% (e.g., about 4.5%) by weight, of the composition.

In certain embodiments, a plasticizer is included in the coating composition to improve peelability and to prevent cracking of the protective film during use. Essentially any compound capable of plasticizing a vinyl-acrylic copolymer emulsion and/or a vinyl acetate ethylene emulsion is suitable. Preferred plasticizers include, but are not limited to TEXANOL® (2,2,4-Trimethyl-1,3-pentanediol monoisobutyrate Propionic acid, 2-methyl-, monoester with 2,2,4-trimethyl-1,3-pentanediol Isobutyric acid ester with 2,2,4-trimethyl-1,3-pentanediol, C₁₂H₂₄O₃) available from Eastman Co., and PARAPLEX® (e.g., PARAPLEX® WP-1) available from Rohm and Haas. The plasticizer, if present is typically present at a concentration ranging from about 0.01 to about 10%, preferably from about 0.1% to about 5%, more preferably from about 0.2% to about 4%, and most preferably from about 1% or 2% to about 3% or 4%, by weight, of the coating composition before drying. In applications where the coating composition or protective film formed therefrom is subject to high temperature, Paraplex can be used in place of Texanol to reduce odors.

While in most embodiments, a releasing agent is unnecessary, in some contexts, it is desirable to add releasing agents to facilitate the peelability of the film. Suitable releasing agents include, but are not limited to natural and synthetic waxes, wax emulsions (e.g., #110 available from Michelman, Cincinnati, Ohio, USA), lecithin, and surfactants with a hydrophile-lipophile balance (HLB) ranging from about 8 to about 10.

The coating composition can additionally include a thickener. Preferred thickeners show little or no water sensitivity. Suitable thickeners are well known to those of skill in the art and include, but are not limited to, Carbopol™ EPI (Noveon, Inc.), Montmorillonite, EZ-1, BFG, Acrysol™ (e.g. Acrysol™ ASC 95), Rheolate™ (e.g. Rheolate™ 450, Rheox Co.) and the like with Acrysol™ ASC 95 and Rheolate™ 450 or combinations thereof being most preferred. The thickener may be present at up to about 30%, by weight of the composition, but it is preferably present at up to about 5%, more preferably at up to about 3%, and most preferably at up to about 1%, by weight of the composition.

In various embodiments the composition can include a “neutralizer” or a “pH adjuster” to adjust the pH of the composition. Means of adjusting pH are well known to those of skill in the art. Particularly where a polymer emulsion is present it is desirable to add a base to neutralize the emulsion. This may be accomplished by the addition of one of a number of water soluble bases well known to those of skill in the art. These include, but are not limited to sodium hydroxide, sodium bicarbonate, calcium carbonate, and amine bases such as pyridine and ethylamine and ammonia. In certain preferred embodiments, the neutralizer comprises NaOH and/or calcium carbonate and the composition is adjusted to a neutral pH.

Certain embodiments, particularly sprayable formulations, comprise a defoamer. Compatible defoamers are well known to those of skill in the art. One particularly preferred defoamer is Henkle Foamaster FM-O. The defoamer when present, ranges from about 0.1% to about 5%, preferably about 0.2% to about 3%, more preferably about 0.3% to about 2%, and most preferably about 0.4% to about 1% of the coating composition before drying.

In certain embodiments, the coatings preferably include a biocide or preservative to improve shelf life and to help prevent degradation of the wet composition and/or the protective film formed therefrom. Compatible biocides are well known to those of skill in the art. One particularly preferred biocide is Kathon LX 14 (a/r). The biocide, when present is typically at a concentration sufficient to reduce or eliminate bacterial, algal, fungal, or other biological growth or degradation produced by microorganisms. Preferred biocide concentrations, when present, are less than about 5%, preferably less than about 3%, more preferably less than about 1%, and most preferably less than about 0.1%.

In certain embodiments the coating composition can be formulated with other film formers in addition to the vinyl-acrylic copolymer or ethylene vinyl acetate. Additional film formers suitable for use in this invention include, but are not limited to vinyl chloride copolymers, acrylic latex (e.g., 1324, B.F. Goodrich), acrylic copolymer emulsions (e.g., Hycar™ 2679, Noveon), and styrene acrylic copolymers (e.g., Carboset™ 958, Noveon). When used, the additional film formers can be present at up to about 90 percent, by weight of the coating, however, in a preferred embodiment, they are present at less than about 50 percent, more preferably less than about 20 percent and most preferably less than about 10 percent, by weight of the composition.

In various embodiments the coating compositions of this invention comprise the formulations shown in Table 3.

TABLE 3
Certain illustrative formulations.

| | | Powerwrap | |
|---|---|---|---|
| | | NF | Spraywrap |
| | Range | Percentage | RT |
| Ingredient | Percentage | per unit | Percentage |
| Film Former | 30%-98% | 62.24% | 64.528 |
| (Air Products | | | |
| FLEXBOND ® 325) | | | |
| Plastisizer | 0.1%-10% | 3.00% | 3.00% |
| (Texanol) | | | |
| Thickener | 0.01%-5.0% | 0.38% | 0.562 |
| Noveon, Carbopol EP-1 | | | |
| H₂O | | 0.30% | |
| Base | 0.05%-3.0% | 0.45% | 0.60% |
| Ammonia Hydroxide, | | | |
| Technical | | | |
| Grade Pigment | 0.5-10 | 4.50% | 4.50% |
| (Titanium Dioxide 60% | | | |
| Solution) | | | |
| Biocide | 0.001-0.1 | 0.01% | 0.01% |
| (Rohm and Hass Kathon | | | |
| LX 14 | | | |
| (a/r)) Thickener | 0.01%-5% | 0.75% | — |
| Rohm and Haas Acrysol | | | |
| RM 825 | | | |
| H₂0 | | 1.88% | — |
| Buffer | 0.01%-5% | 0.75% | 0.75% |
| Calcium Carbonate | | | |
| H2O | | 0.75% | 0.75% |
| Fire retardant | 5%-50% | 25.00% | 25.00% |
| Avtec Industries Eco | | | |
| Additive 20 | | | |
| total solids | | 100% | 100% |

These formulations are intended to be illustrative and not limiting. Using the teachings provided herein, other suitable formulations will be available to one of skill in the art.

The vinyl-acrylic copolymer and vinyl acetate-ethylene emulsions, while applied as a liquid, will form a substantially continuous solid sheet when dried. Drying may be accomplished at room temperature (i.e., by air drying). However, dry time may be reduced using heat (e.g., using infra red heat lamps, hot air blowers, oven baking, or other heat sources).

As indicated above, it was a surprising discovery of this invention that vinyl-acrylic copolymer and vinyl acetate-ethylene emulsions, even when combined with a flame retardant as described herein, can be used as protective (peel-off) coatings of that can be peeled a wide variety of surfaces coatings once cured. A “peelable” or “peel-off” coating is one that may be removed from the surface it coats simply by mechanical peeling. A peel-off coating preferably possesses sufficient flexibility, tensile and tear strength so that it does not fracture during peeling. The required flexibility, tensile and tear strength is a function of the strength of adhesion of the coating to the underlying surface. In a preferred embodiment, the adhesive ability of the film is sufficient to keep it completely bound to the underlying substrate throughout the period of protection and yet remain fully peelable at the time of removal. It is particularly preferred that the peel-off coating peel without trouble or without being torn in pieces. The coating when peeled should not remain partially unpeeled, leaving portions adhering to the substrate.

The vinyl-acrylic copolymer and vinyl acetate-ethylene emulsions used in the practice of the methods of his invention can be peeled off a wide variety of surfaces. These include, but are not limited to, metal, glass, plastic, painted wood, marble, laminate, plated surfaces, and the like.

In one embodiment, this invention provides a method of protecting surfaces wherein a substantially continuous film of a vinyl-acrylic copolymer or a vinyl acetate-ethylene emulsion combined with a flame retardant is applied to the surface to be protected. The coating composition is applied by one of a variety of techniques including, but not limited to, application by brush, roller, spray, dipping, spreading (e.g. using a doctor bar), etc. Preferred techniques include roller application, brushing, and spraying of the surface with the coating composition. In some cases, additional water may be added for easier application, such as a 10% dilution. Thereafter, the coating composition may be applied with a pressure pot sprayer, preferably first in a thin mist and, thereafter, in a flow coat or thicker substantially continuous film. The coating composition is sprayed primarily on the surface to be protected, although overspray will not pose significant problems since any overspray may be readily removed with, for example, a wet towel or sponge or after curing by simply peeling the coating off the oversprayed surfaces. The resulting masking coating composition is from about 0.1 to about 30 mils thick, preferably about 0.5 to about 20 mils thick, more preferably from about 1 to about 10 mils thick, with a most preferred thickness of about 5 mils. Of course the thickness will vary depending on the requirements of the user. Thus, for example, where cost is a concern, thin coatings (˜0.1 to 1 mil) are used. Conversely, where impact resistance is desired the coatings may have a thickness in excess of 30 mils.

In certain embodiments, the coating composition is applied in an aerosol form to a surface. In such embodiments, the composition can be stored in a container pressurized with any of a number of propellants including such environmentally benign materials as dimethyl ether, nitrogen, or carbon dioxide. Alternatively, the composition can be stored in a pump-type spray can.

After application to a surface, the coating composition is permitted to dry. As explained above, the coating can be air dried or force dried by any of a number of methods well known to those of skill in the art.

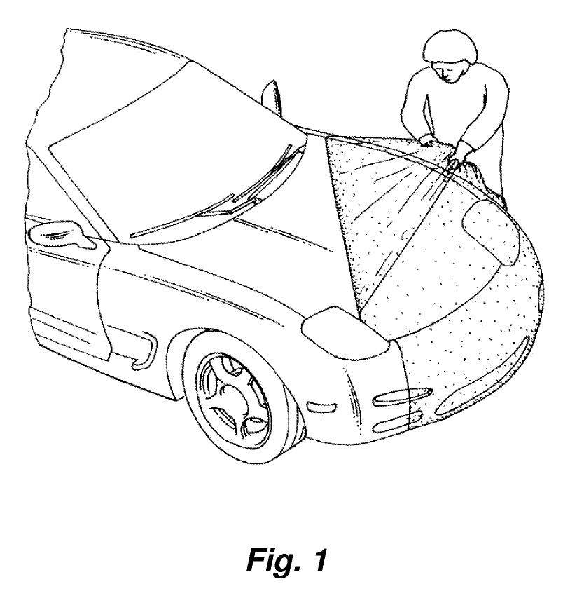

One of skill in the art will recognize that, in certain embodiments, the coatings of this invention can be utilized as part of a method of transporting vehicles which protects the exterior portions of the vehicle from scratches. Generally, any of the above-described surface protective coating compositions is applied to the surface to be protected, the vehicle is transported, and the protective coating is then removed from the surfaces by simple mechanical peeling as illustrated in FIG. 1. For example, cars to be loaded onto auto-carriers (either road or rail) are first cleaned of surface debris and dust and then coated with either of the surface protective coating compositions of the invention as described above. The cars are then transported to their destination where the surface protective coating is removed by peeling. Peeling may be accomplished by hand or with the aid of mechanical devices.

In various embodiments, the coatings of the present invention may be applied to protect sensitive finishes on most any item exposed to deleterious environmental factors. For example, the composition of this invention can be used to coat glass and chrome products being transported or otherwise held or stored, building materials such as formica and bathroom fixtures, certain plastic materials, ships and boats (e.g., ships and boats being stored outdoors, particularly during winter), chrome tanks (e.g., on tank trucks), and vehicles generally (e.g., cars, trucks, buses, construction machinery, etc.), oil and gas rigs, windmills, gas lines, aircraft, and the like. Further, vehicle windshields and finishes can be protected against accumulations of insects and other bugs in environments where they are a problem. It has also been found that coatings prepared according to the present invention can be used to protect against graffiti. The paint from graffiti is simply peeled off with the protective coating.

A particularly useful application of the present invention is to protect wheels and tires of vehicles during normal use. In these embodiments, the coating composition is applied to the wheel and/or tire in the manner described above. Typically, a black layer of brake dust accumulates on wheels during normal operation. Because the wheels and tires are coated with the removable coating composition of this invention, the brake dust (and other accumulated dirt) is easily removed by peeling off the coating. The resulting clean wheel and tire can be re-coated with another layer of the coating composition.

Any of the coating compositions of this invention can also be used as a sacrificed layer to protect various items that are not necessarily associated with transportation. For example, various building fixtures found in bathrooms and most other rooms can be protected. Bathtubs, shower stalls, bathroom tiles and floors, etc. are all adversely affected by steam, mineral deposits from water, and soap scum. Much labor is expended by homeowners or maintenance personnel to remove bathroom deposits. The removable coating compositions of this invention are used to temporarily protect bathroom fixtures during normal use. When it is time to clean the bathroom, the coating is simply peeled from the underlying surfaces thereby removing the coating composition together with the accumulated dirt.

The coatings of this invention are tough, relatively thick, and provide a high degree of resistance to mechanical abrasion. They are therefore particularly suitable for protecting component parts during installation. Thus, for example, in bathroom components such as bathtubs, toilets, sinks and shower units are often damaged by contact with abrasives during installation. Workers often stand in or on these items and scratch their surfaces. Such damage is especially common when there is dirt or gravel in the tub and a worker standing in the tub, on top of the gravel grinds the gravel into the tub's surface with his feet. Additionally, because these items are typically left outside on the job site, the coatings' water resistant feature becomes very important.

Similarly the coatings can be used to protect components in automotive assembly plants, or to protect automotive components in repair shops or body shops. Other fixtures that can be protected by this invention include, but are not limited to banisters, electrical light switch plates, door knobs, windows, etc. Particularly preferred surfaces for coating include metals such as brass or chrome, ceramic, glass, and plastic laminates such as FORMICA®.

Similarly, the coatings of this invention may protect component parts during assembly in an industrial setting. Thus, for example, component plastic bumpers may be coated to protect against scratching and other damage from the time they are produced, through the car assembly process, and until the car arrives at the dealership. The coatings may provide a rough easily gripped surface and therefore utilized to facilitate the gripping and manipulation of highly machined components without component scratching or other damage.

The coatings can also be used to maintain clean component parts until the time of use. Thus the coatings may be utilized to allow easy removal of accumulated layers of oil and grit, often present in factory environments, from metallic components awaiting assembly. The coating may be quickly peeled from the component just before use thereby removing the accumulated contaminating materials.

Because of their toughness, the coatings of this invention are also suitable for coating and protecting floor surfaces in highly trafficked areas. The compositions may be compounded with various particulate materials to enhance traction.

In addition, because of their stability to high temperatures for prolonged periods of time, the coatings of this invention are suitable for use as peelable paint-booth coatings.

Furniture may also be protected by the methods of this invention. In particular, lawn furniture and umbrellas can be protected by the coating compositions of this invention. In preferred embodiments, an ultra-violet radiation blocker is added to the coating composition to protect outdoor furniture and umbrellas from the effects of sunlight. Automobile upholstery can also be protected by the methods of this invention. It should be noted that many of the protected surfaces tend to flex during normal use. For example, tires continually compress as they roll. In addition, pliable lawn furniture stretches when used. For these applications, the coating compositions of this invention must be sufficiently pliable to ensure that they do not crack during flexure. It should be noted that the coating composition also protects surfaces from the deleterious effects of ozone, the ubiquitous pollutant formed in smog. It is known that ozone attacks rubbers and other elastomers, causing them to crack. By applying the coating compositions of this invention, cracking associated with ozone is reduced.

One of skill will appreciate that the protective coating need not be removed immediately from the article that it protects. To the contrary, the coating provides an effective protectant during periods of prolonged storage. Thus, in another embodiment, this invention provides for a composition comprising an article of manufacture having a surface coated with a protective coating composition (e.g. a vinyl-acrylic copolymer film or a vinyl acetate-ethylene film. The article of manufacture can be virtually any article of manufacture as described above.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A method of protecting a surface, said method comprising:
i) applying to said surface a liquid coating composition comprising:
an emulsion selected from the group consisting of a vinyl-acrylic copolymer and a vinyl acetate ethylene emulsion;
a plasticizer; and
a fire retardant;
ii) drying said coating composition to form, on said surface, a substantially continuous protective film.

2. The method of claim 1, wherein said emulsion is an aqueous emulsion.

3. The method of claim 2, wherein said emulsion is a vinyl acrylic copolymer emulsion.

4. The method of claim 1, wherein said emulsion is selected from the group consisting of FlexBond 325, FlexBond 381, and Airflex 320.

5. The method of claim 1, wherein said plasticizer is selected from the group consisting of Paraplex™ WP1, and Texanol™.

6. The composition of claim 1, wherein said fire retardant comprises a catalyst/initiator; a carbonific, a cement, a blowing agent, and a heat-resistant inorganic material.

7. The composition of claim 6, wherein said flame retardant comprises TSWB™ (Avtec Industries).

8. The method of claim 1, wherein said coating composition further comprises a pigment.

9. The method of claim 8, wherein said pigment is titanium dioxide.

10. The method of claim 1, wherein said coating composition further comprises a thickener.

11. The method of claim 1, wherein said coating composition further comprises a defoamer.

12. The method of claim 1, wherein said coating composition further comprises a biocide.

13. The method of claim 1, wherein:
said emulsion is a vinyl-acrylic copolymer emulsion comprising at least 50%, by weight, of said coating composition before drying;
said plasticizer comprises about 1% to about 5%, by weight, of said coating composition before drying; and
said fire retardant comprises about 15% to about 30%, by weight of said composition.

14. The method of claim 13, wherein said composition further comprises a thickener, wherein said thickener comprises less than about 3%, by weight, of said coating composition before drying.

15. The method of claim 14, wherein said composition comprises a pigment, and said pigment comprises less than about 10%, by weight, of said coating composition before drying.

16. The method of claim 15, wherein said coating composition further comprises a defoamer.

17. The method of claim 1, wherein said coating composition comprises a formulation shown in Table 3.

18. The method of claim 1, wherein said applying is by a means selected from the group consisting of a sprayer, a brush, a roller, and a doctor bar.

19. The method of claim 1, wherein said applying comprises air drying said composition at room temperature.

20. The method of claim 1, wherein said method further comprises removing said composition from said surface.

21. The method of claim 1, wherein said removing comprises peeling said composition from said surface.

22. The method of claim 1, wherein said surface is a surface of an article of manufacture selected from the group consisting of a motor vehicle, a motor vehicle component, a bathroom fixture, a plumbing fixture, a tool, a machine, a laminated countertop, a table top, a window assembly, a door assembly, a stove, a refrigerator, a microwave oven, an aluminum tank, a wheel, furniture, a plated or chromed part, a bumper, an instrument panel, a part of an oil rig, a part of an aircraft, a part of a windmill, a shelf, and a cabinet.

23. As an article of manufacture, a surface coated with a protective coating composition where said coating composition, before drying comprises:
an emulsion selected from the group consisting of a vinyl-acrylic copolymer and a vinyl acetate ethylene emulsion;
a plasticizer; and
a fire retardant.

24. The article of manufacture of claim 23, wherein said emulsion is an aqueous emulsion.

25. The article of manufacture of claim 23, wherein said emulsion is a vinyl acrylic copolymer emulsion.

26. The article of manufacture of claim 23, wherein said emulsion is selected from the group consisting of FlexBond 325, FlexBond 381, and Airflex 320.

27. The article of manufacture of claim 23, wherein said plasticizer is selected from the group consisting of Paraplex™ WP1, and Texanol™.

28. The article of manufacture of claim 23, wherein said fire retardant comprises a catalyst/initiator; a carbonific, a cement, a blowing agent, and a heat-resistant inorganic material.

29. The article of manufacture of claim 28, wherein said flame retardant comprises TSWB™ (Avtec Industries).

30. The article of manufacture of claim 23, wherein said coating composition further comprises a pigment.

31. The article of manufacture of claim 23, wherein said pigment is titanium dioxide.

32. The article of manufacture of claim 23, wherein said coating composition further comprises a thickener.

33. The article of manufacture of claim 23, wherein said coating composition further comprises a defoamer.

34. The article of manufacture of claim 23, wherein said coating composition further comprises a biocide.

35. The article of manufacture of claim 23, wherein:
said emulsion is a vinyl-acrylic copolymer emulsion comprising at least 50%, by weight, of said coating composition before drying;
said plasticizer comprises about 1% to about 5%, by weight, of said coating composition before drying; and
said fire retardant comprises about 15% to about 30%, by weight of said composition.

36. The article of manufacture of claim 23, wherein said composition further comprises a thickener, wherein said thickener comprises less than about 3%, by weight, of said coating composition before drying.

37. The article of manufacture of claim 23, wherein said composition comprises a pigment, and said pigment comprises less than about 10%, by weight, of said coating composition before drying.

38. The article of manufacture of claim 23, wherein said coating composition comprises a formulation shown in Table 3.

39. A protective coating composition comprising:
n aqueous mixture of:
an emulsion selected from the group consisting of a vinyl-acrylic copolymer and a vinyl acetate ethylene emulsion;
a plasticizer; and
a fire retardant.

40. The composition of claim 39, wherein said emulsion is an aqueous emulsion.

41. The composition of claim 39, wherein said emulsion is a vinyl acrylic copolymer emulsion.

42. The composition of claim 39, wherein said emulsion is selected from the group consisting of FlexBond 325, FlexBond 381, and Airflex 320.

43. The composition of claim 39, wherein said plasticizer is selected from the group consisting of Paraplex™ WP1, and Texanol™.

44. The composition of claim 39, wherein said fire retardant comprises a catalyst/initiator; a carbonific, a cement, a blowing agent, and a heat resistant inorganic material.

45. The composition of claim 44, wherein said flame retardant comprises TSWB™ (Avtec Industries).

46. The composition of claim 39, wherein said coating composition further comprises a pigment.

47. The composition of claim 39, wherein said pigment is titanium dioxide.

48. The composition of claim 39, wherein said coating composition further comprises a thickener.

49. The composition of claim 39, wherein said coating composition further comprises a defoamer.

50. The composition of claim 39, wherein said coating composition further comprises a biocide.

51. The composition of claim 39, wherein:
said emulsion is a vinyl-acrylic copolymer emulsion comprising at least 50%, by weight, of said coating composition before drying;
said plasticizer comprises about 1% to about 5%, by weight, of said coating composition before drying; and
said fire retardant comprises about 15% to about 30%, by weight of said composition.

52. The composition of claim 51, wherein said composition further comprises a thickener, wherein said thickener comprises less than about 3%, by weight, of said coating composition before drying.

53. The composition of claim 52, wherein said composition further comprises a pigment, and said pigment comprises less than about 10%, by weight, of said coating composition before drying.

54. The composition of claim 39, wherein said coating composition comprises a formulation shown in Table 3.

55. A method of transporting an article of manufacture, said method comprising:
i) applying to a surface of said article of manufacture a coating composition comprising according to claims 39;
ii) drying said coating composition to form, on said surface, a substantially continuous protective film; and
iii) transporting said article.

56. The method of claim 55, wherein said method further comprises removing said protective coating composition after transporting said article of manufacture.

57. The method of claim 56, wherein said removing is by mechanical peeling.
